(19) United States
(12) Patent Application Publication
(10) Pub. No.: US 2013/0049674 A1
(43) Pub. Date: Feb. 28, 2013

(54) INTEGRATED PHOTO VOLTAIC SOLAR PLANT AND ELECTRIC VEHICLE CHARGING STATION AND METHOD OF OPERATION

(71) Applicant: Roy Howard Davis, Del Mar, CA (US)

(72) Inventor: Roy Howard Davis, Del Mar, CA (US)

(73) Assignee: QUALCOMM Incorporated, San Diego, CA (US)

(21) Appl. No.: 13/420,330

(22) Filed: Mar. 14, 2012

Related U.S. Application Data
(60) Provisional application No. 61/526,964, filed on Aug. 24, 2011.

(51) Int. Cl. H02J 7/00

(52) U.S. Cl. 320/101

(57) ABSTRACT

Systems, methods and apparatus are disclosed for using renewable energy sources as broadband AC to DC conversion. In one aspect, an apparatus configured for charging an electric vehicle is provided. The apparatus includes a power supply circuit configured to convert direct current received from a renewable power source into alternating current. The alternating current is having a frequency. The apparatus further includes a power transmit circuit configured to receive the alternating current from the power supply circuit and to provide power to charge the electric vehicle using the alternating current. The power transmit circuit is further configured to substantially resonate at the frequency of the alternating current.

### CROSS REFERENCE TO RELATED APPLICATIONS

This application claims priority under 35 U.S.C. §119(e) to U.S. Provisional Patent Application No. 61/526,964 entitled “INTEGRATED PHOTO VOLTAIC SOLAR PLANT AND ELECTRIC VEHICLE CHARGING STATION” filed on Aug. 24, 2011, the disclosure of which is hereby incorporated by reference in its entirety.

### FIELD

The invention relates generally to charging electric vehicles. More specifically, the disclosure is directed to using solar power to provide power to an electric vehicle charging system.

### BACKGROUND

An increasing number and variety of systems may be powered via rechargeable batteries. Remote systems, such as vehicles, have been introduced that include locomotion power derived from electricity received from an energy storage device such as a battery. For example, hybrid electric vehicles include on-board chargers that use power from vehicle braking and traditional motors to charge the vehicles. Vehicles that are solely electric generally receive the electricity for charging the batteries from other sources.

While battery technology has improved, battery-powered systems increasingly require and consume greater amounts of power, thereby often requiring recharging. Battery electric vehicles (electric vehicles) are often proposed to be charged through some type of wired alternating current (AC) such as household or commercial AC supply sources. The wired charging connections require cables or other similar connectors that are physically connected to a power supply. Cables and similar connectors may sometimes be inconvenient or cumbersome, have safety issues and have other drawbacks. Wireless charging systems that are capable of transferring power with no exposed contacts in free space (e.g., via a wireless field) to be used to charge rechargeable systems or provide power may overcome some of the deficiencies of wired charging solutions. As such, wireless power transfer systems and methods that efficiently and safely transfer power are desirable.

### SUMMARY OF THE INVENTION

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the subject matter described in the disclosure provides an apparatus configured for charging an electric vehicle. The apparatus includes a power supply circuit configured to convert direct current received from a renewable power source into alternating current having a frequency. The apparatus further includes a power transmit circuit configured to receive the alternating current from the power supply circuit and to provide power to charge the electric vehicle using the alternating current. The power transmit circuit is further configured to substantially resonate at the frequency of the alternating current.

Another aspect of the subject matter described in the disclosure provides an implementation of a method for charging an electric vehicle. The method includes converting direct current received from a renewable power source into alternating current having a frequency. The method further includes providing power to charge the electric vehicle via a power transmit circuit configured to use the alternating current. The power transmit circuit is further configured to substantially resonate at the frequency of the alternating current.

Yet another aspect of the subject matter described in the disclosure provides an apparatus for charging an electric vehicle. The apparatus includes means for converting current configured to convert direct current received from a renewable power source into alternating current having a frequency. The alternating current further includes means for transferring power configured to receive the alternating current from the means for converting current and to provide power to charge an electric vehicle using the alternating current. The means for transferring power is further configured to substantially resonate at the frequency of the alternating current.

### BRIEF DESCRIPTION OF THE DRAWINGS

FIG. 1 is a functional block diagram of an exemplary wireless power transfer system, in accordance with various exemplary embodiments of the invention.

FIG. 2 is a functional block diagram showing exemplary components that may be used in a wireless power transfer system like the system shown in FIG. 1, in accordance with various exemplary embodiments of the invention.

FIG. 3 is a functional block diagram of an exemplary charging base system that may be used in the wireless power transfer system of FIG. 2, in accordance with various exemplary embodiments of the invention.

FIG. 4 is a functional block diagram of an exemplary charging receiver system that may be used in the wireless power transfer system of FIG. 2, in accordance with various exemplary embodiments of the invention.

FIG. 5 is a diagram of an exemplary system for charging an electric vehicle that may include the wireless power transfer system of FIG. 2, in accordance with various exemplary embodiments of the invention.

FIG. 6 is a functional block diagram of an exemplary photo voltaic (PV) power system that provides power to a utility grid that could be used as a power source for an electric vehicle charging system.

FIG. 7 is a chart showing an exemplary amount of solar power available during a period of a day when using an exemplary PV power source.

FIG. 8 is a chart illustrating an amount of solar energy produced by an exemplary photo voltaic source (i.e., photo voltaic installation) over a time period of one month.

FIG. 9A is a functional block diagram of an exemplary wired charging base system that receives power from a PV power system via an AC power utility grid.

FIG. 9B is a functional block diagram of an exemplary wireless charging base system that receives power from a PV power system via an AC power utility grid.

FIG. 10 is a functional block diagram of additional components that may be used for power conversion in the exemplary systems shown in FIG. 9B.

FIG. 11 is a functional block diagram of a base charging system, in accordance with various exemplary embodiments of the invention.

FIGS. 12A, 12B, 12C, and 12D are functional block diagrams of different configurations of base charging systems receiving power from PV power systems, in accordance with various exemplary embodiments of the invention.

FIGS. 13A, 13B, 13C, 13D, and 13E are plots of DC and AC voltage waveforms for both single phase and polyphase power conversion systems.

FIG. 14 is a schematic diagram of an exemplary three phase rectifier circuit, in accordance with an exemplary embodiment of the invention.

FIG. 15 is a flow chart of an exemplary method for charging an electric vehicle, in accordance with various exemplary embodiments of the invention.

FIG. 16 is a functional block diagram of a charging base system for charging an electric vehicle, in accordance with an exemplary embodiment of the invention.

### DETAILED DESCRIPTION

The detailed description set forth below in connection with the appended drawings is intended as a description of exemplary embodiments of the invention and is not intended to represent the only embodiments in which the invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

The term “wireless power” is used herein to mean any form of energy associated with electric fields, magnetic fields, electromagnetic fields, or otherwise that is transmitted between a “transmit circuit” or transmitter and a “receive circuit” or receiver without the use of physical electrical conductors. Hereafter, all three of these will be referred to generically as fields, with the understanding that pure magnetic or pure electric fields do not radiate power. These may be coupled to a receive circuit to achieve power transfer.

Non-contact wireless power transmission for charging or operation may be achieved by magnetic coupling between a primary coil of wire and a secondary coil of wire. The mechanism may be similar to that of an alternating current electric transformer where the power may be converted from an alternating electric current in the primary winding into an alternating magnetic field that is coupled by a magnetic circuit, usually made up of iron or iron bearing material, to a secondary winding where the magnetic field is converted back to an alternating electric current (AC). Other circuits convert the power received to direct current (DC) for charging the battery.

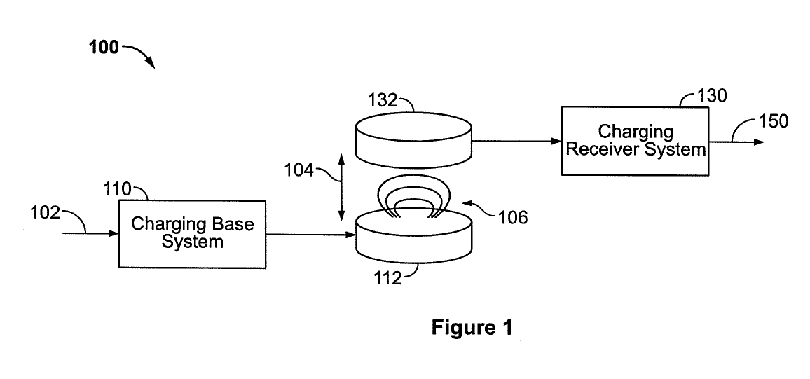

FIG. 1 is a functional block diagram of an exemplary wireless power transfer system 100, in accordance with various exemplary embodiments of the invention. Input power 102 is provided to a charging base system 110, which converts the input power 102 to a form appropriate to drive a transmit coil 112, which generates a field 106 for providing power transfer. A receive coil 132 couples to the field 106 and generates electric power, which is rectified and filtered by a charging receiver system 130, which is converted for storing or consumption (e.g., charging) by a device (not shown) coupled to the output power 150. Both the transmit and receive coils 112 and 132 are separated by a distance 104.

The transmit coil 112 and the receive coil 132 may be sized according to applications and devices to be associated therewith. An efficient energy transfer occurs by coupling a large portion of the energy of the field 106 of the transmit coil 112 to the receive coil 132 rather than propagating most of the energy in an electromagnetic wave to the far field. When in this field 106, a coupling mode may be developed between the transmit coil 112 and the receive coil 132. The area around the transmit coil 112 and the receive coil 132 where this coupling may occur may be referred to herein as a coupling mode region.

Either the transmit coil 112 or the receive coil 132 may also be referred to or be configured as a “loop” antenna. The transmit coil 112 or the receive coil 132 may also be referred to herein or configured as a “magnetic” antenna or an induction coil. The term “coil” is intended in one aspect to refer to a component that may wirelessly output energy for coupling to another “coil” or receiving or coupling from another “coil.” The coil may also be referred to as an “antenna” of a type that is configured to wirelessly provide power transfer. The coil may also be referred to as a wireless power transfer component that is configured to wirelessly provide power transfer.

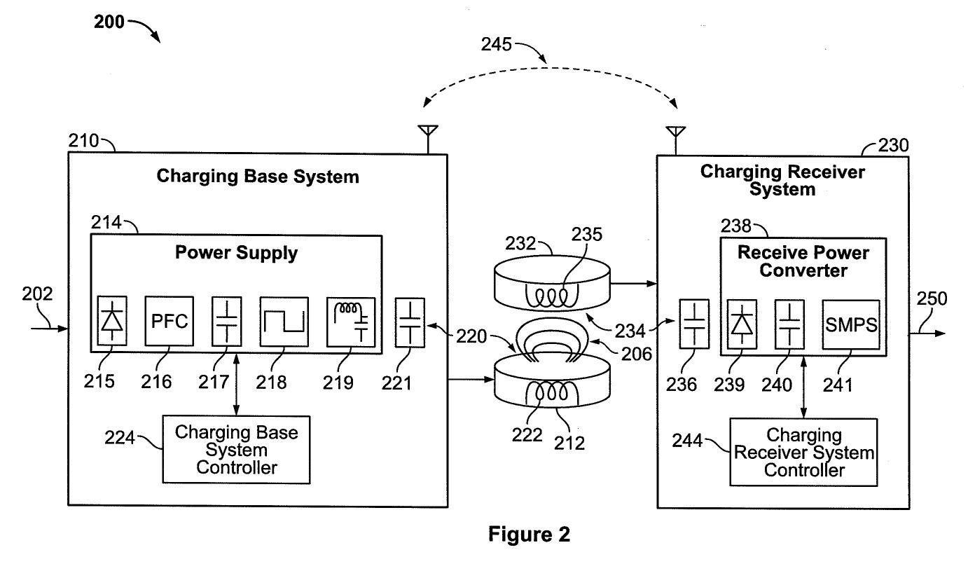

FIG. 2 is a functional block diagram showing exemplary components that may be used in a wireless power transfer system 200 like the system 100 shown in FIG. 1, in accordance with various exemplary embodiments of the invention. A charging base system 210 may include a power supply 214 that may be configured to receive input power 202, such as, for example, utility power at 50/60 Hz and convert it to a high frequency AC to drive a transmit coil 212. The transmit coil 212, forming an inductor 222, may be included in a power transmit circuit 220 that may also include a capacitor 221 electrically connected either in series or in parallel to the transmit coil 212. The power transmit circuit 220 may resonate at a particular operating frequency. The power supply 214 may include a rectifier 215 that converts the utility AC power into pulsating DC. For large loads, power factor correction circuitry 216 may be included in the power supply 214 to avoid excessive currents flowing in the utility grid. The pulsating DC may be filtered by a large energy storage element 217 into a constant DC. The power supply 214 further includes a chopper circuit 218 configured to convert the constant DC into a high frequency square wave. The power supply 214 further includes a filter 219 to filter the output of the chopper circuit into a sine wave. This output may be then connected to the power transmit circuit 220. A high frequency AC current flowing in the power transmit circuit 220 creates a pulsating high frequency magnetic field 206. As stated, the transmit coil 212 and the capacitor 221 may form a resonant power transmit circuit 220 at the frequency of operation, producing improved magnetic coupling between the transmit coil 212 and the receive coil 232. In some embodiments, the transmit coil 212 may have an inherent capacitance selected such that it is configured to resonate, such that the transmit coil 212 is self resonant and would not require the capacitor 221. The charging base system 210 may be configured to transfer at least 1 kilowatt of power or more. The charging base system 224 additionally includes a charging base system controller 224 that may be configured to control various components of the charging base system 210 such as the power supply 214.

The wireless power transfer system 200 includes a charging receiver system 230. The charging receiver system 230 includes a receive coil 232 forming an inductor 235 that is configured to couple to the pulsating high frequency magnetic field 206 and is configured to generate a high frequency AC power, which is electrically connected to a receive power converter 238. The receive coil 232 may form part of a power receive circuit 234 that may also include a capacitor 236 to form a resonant power receive circuit 234 at the frequency of operation, producing improved magnetic coupling between the transmit coil 212 and the receive coil 232. The receive power converter 238 includes a rectifier 239 that converts the AC power to pulsating DC. The receive power converter 238 may further include an energy storage device 240 (e.g., a capacitor) to smooth the pulsating DC into constant DC. The receive power converter 238 may include a switch mode power supply 241 configured to adjust the voltage to a value appropriate for charging a battery (not shown) via the output power 250. The charging base system 210 and the charging receiver system 230 may communicate by modulating the field 206, or on a separate communication channel 245 (e.g., Bluetooth, zigbee, cellular, NFC, etc). The charging receiver system 230 further includes a charging receiver system controller 244 that is configured to control the various components of the charging receiver system 230 including the receive power converter 238.

In one exemplary embodiment, the transmit coil 212 and receive coil 232 are configured according to a mutual resonant relationship and when the resonant frequency of power receive circuit 234 and the resonant frequency of power transmit circuit 220 are very close, transmission losses between the transmit coil 212 and the receive coil 232 are minimal when the receive coil 232 is located in the region where the majority of the flux lines of the field 206 pass near or through the receive coil 232.

Efficient transfer of energy between the transmit coil 212 and receive coil 232 may occur during matched or nearly matched resonance between the power transmit circuit 220 and the power receive circuit 234. However, even when resonance between the power transmit circuit 220 and power receive circuit 234 are not matched, energy may be transferred, although the efficiency may be affected. As stated, transfer of energy occurs by coupling energy from an energy field 206 (e.g., in the near field) of the transmit coil 212 to the receive coil 232 residing in the neighborhood where this field 206 is established rather than propagating the energy from the transmit coil 212 into free space. The field 206 may correspond to a region in which there are strong reactive fields resulting from the currents and charges in the transmit coil 212 that do not radiate power away from the transmit coil 212. In some cases the field 206 may correspond to the near-field corresponding to a region that is within about one 1/2π wavelength of the transmit coil 212.

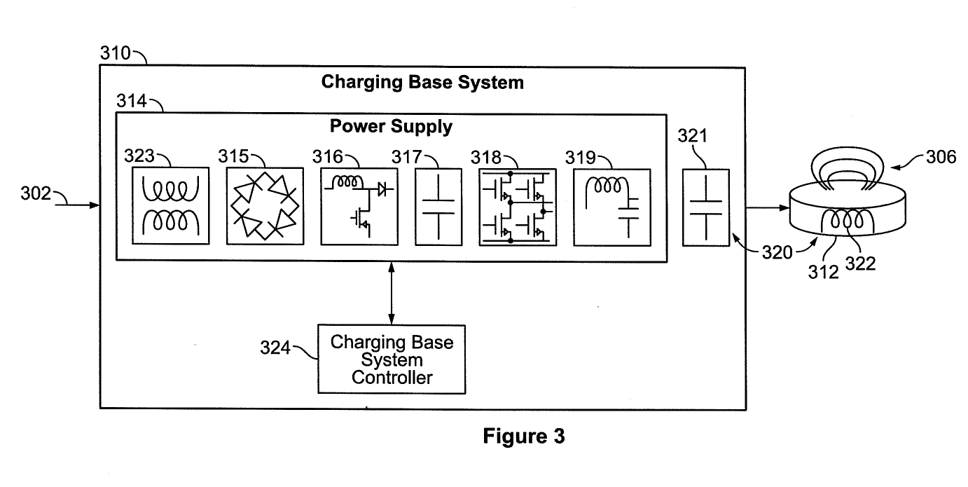

FIG. 3 is a functional block diagram of an exemplary charging base system 310 that may be used in the wireless power transfer system 200 of FIG. 2, in accordance with various exemplary embodiments of the invention. The charging base system 310 includes a power supply 314 with components to show an exemplary configuration for converting 50/60 Hz utility grid power into a high frequency AC that may be used to drive a transmit coil 312, while other configurations are possible for other input power sources. The power supply circuit 314 may include a line filter 323 configured to remove high frequency noise and damaging voltage spikes from the 50/60 Hz utility grid power 302. The line filter 323 may include inductors, capacitors and overvoltage devices (not shown). The inductors (not shown) may have large magnetic cores to avoid saturation and may be wound with heavy copper wire to avoid losses at high power levels. All the components may be rated for utility line voltages and frequency. The power supply 314 includes a rectifier 315 that is configured to convert the 50/60 Hz AC to pulsating DC. The rectifier diodes may be rated for the line voltage and current levels required to power or charge a receiving system (not shown). Silicon diodes may be replaced with Schottky rectifiers for improved efficiency due to lower voltage drop across the diode.

The power supply 314 may include an active power factor correction circuit 316 for regulatory purposes to avoid excess currents in the utility grid due to out of phase voltage and current and harmonic distortion caused by the switching action of the rectifier 315. The power factor correction circuit 316 may regulate the flow of current from the utility grid so that it follows the utility grid voltage and appears as a resistive load with good power factor. The power factor correction circuit 316 may be similar to a switch mode power supply that draws current from the utility grid in a series of high frequency pulses that are modulated to match the utility grid voltage waveform. The components used may work at a high frequency so the inductors may be smaller than utility grid frequency inductors.

The power supply 314 may further include an energy storage element 317 that may be a large capacitor or it may be composed of inductors and capacitors and configured to smooth the pulsating DC. In either case, the components may be large in order to store enough energy to last one half cycle of the 50/60 Hz utility grid power. Lower powered power supplies may omit the energy storage element 317, but the resulting high frequency AC power that drives the transmit coil 312 may then have a waveform of the rectified 50/60 Hz utility grid power superimposed as an envelope, leading to higher peak voltages and currents and higher peak magnetic fields. It may be desirable to avoid this at various power levels for cost reasons and to avoid violating magnetic field strength restrictions.

The power supply 314 includes a chopper circuit 318 that may be used to convert the rectified and smoothed DC produced by the previous components 323, 315, 316, and 317 and may chop the smoothed DC into a square wave at the frequency of operation of a power transmit circuit 320 including a capacitor 321 and the transmit coil 312 forming an inductor 322. As an exemplary implementation, this frequency could be at 20 KHz, though any frequency could be used that leads to a practical sized transmit coil 312 and receive coil 232 (FIG. 2). Higher frequencies may allow smaller components to be used in both the power supply 314 and the power transmit circuit 320, while lower frequencies may lead to higher efficiency due to lower switching losses. Certain embodiments may use frequencies in the range from 400 Hz to 1 MHz. Other frequencies may also be possible.

The power supply 314 may further include a matching circuit 319 that may be configured to perform dual duty as a filter to convert the square wave generated by chopper circuit 318 to a sine wave with suppressed harmonics and matches the impedance of the chopper circuit 318 to the resonant power transmit circuit 320 made up of capacitor 321 and the transmit coil 312. Since the matching circuit 319 is operating at a high frequency, the components may be relatively small, but may be of high quality to avoid losses. In the power transmit circuit, capacitor 321 may be in parallel with or series with the transmit coil 312, but in any case may be of the highest quality to avoid loss as the current flowing in this device is multiplied by the operating Q of the resonant power transmit circuit 320. Similarly, the transmit coil 312 forming the inductor 322 may be composed of high quality components to avoid loss. Litz wire may be used to increase surface area and make maximum use of the copper in the winding. Alternately, the transmit coil 312 may be made of a metallic strip with the thickness, width and metal type selected to keep resistive losses low. Ferrite material used for the magnetic circuit may be selected to avoid saturation, eddy currents and loss at the frequency of operation.

The power supply 314 may further include a load sensing circuit (not shown) for detecting the presence or absence of active receive coils in the vicinity of the magnetic field 306 generated by the transmit circuit 320. By way of example, a load sensing circuit monitors the current flowing to the chopper circuit 318, which is affected by the presence or absence of a properly aligned receive coil in the vicinity of the magnetic field 306. Detection of changes to the loading on the chopper circuit 318 may be monitored by a charging base system controller 324 for use in determining whether to enable the power factor correction circuit 316 for transmitting energy and to communicate with an active receive coil (e.g., the receive coil 323 of FIG. 2). A current measured at chopper circuit 318 may be further used to determine whether an invalid object is positioned within a charging region of transmit coil 312. The charging base system controller 324 may be further used to control the various components of the power supply 314 or any other components of the charging base system 310.

In exemplary embodiments, a method by which the power supply 314 does not remain on indefinitely may be used. In this case, the power supply 314 may be programmed to shut off after a user determined amount of time. This feature prevents the power supply 314 from running long after a battery is charged. This event may be due to the failure of the charging base system controller 324 to detect the signal sent from a receiver that it is fully charged.

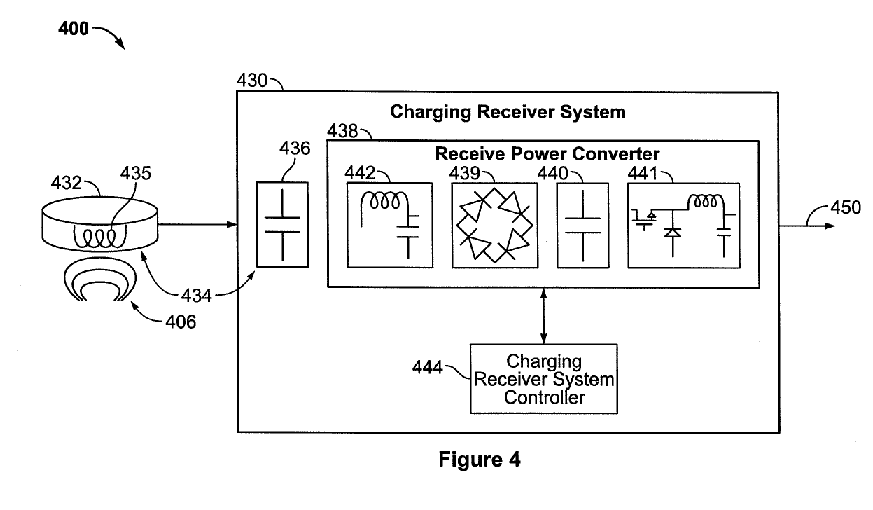

FIG. 4 is a functional block diagram of an exemplary charging receiver system 430 that may be used in the wireless power transfer system 200 of FIG. 2, in accordance with various exemplary embodiments of the invention. The charging receiver system 430 may convert a high frequency magnetic field 406 into high frequency AC power that is converted to DC power 450 used to power a load such as charging a battery (not shown) or powering a device. The charging receiver system 430 may include a receive coil 432 forming an inductor 435 that may form a part of a power receive circuit 434 together with a capacitor 436 to form a resonant power receive circuit 434. The component quality for inductor 407 and capacitor 421 may be high as described above with reference to FIG. 3. The charging receiver system 430 includes a receive power converter 438 to convert high frequency AC power received from the power receive circuit 434. The receive power converter 438 includes a matching circuit 442 that is configured to perform a similar function to matching circuit 319 only in reverse where the high frequency AC power generated by the receive power circuit 434 is impedance matched to a rectifier 439 and the harmonics generated by the rectifier 439 are not coupled to the power receive circuit 434. The rectifier circuit 439 may be configured to reduce the harmonics generated by the rectifying action and reduce the filtering requirements on the matching circuit 442.

The receive power converter 438 may further include an energy storage element 440 that may be used to smooth pulsating DC produced by the rectifier circuit 439 into constant DC. The energy storage element 440 may operate at high frequencies (as compared to the energy storage element 317 of FIG. 3) so components may be smaller. The receive power converter 438 may further include a switch mode power supply 441 configured to regulate the DC voltage and possibly the DC current in response to a battery management system (not shown). As an alternative, the regulating function of the switch mode power supply 441 may be provided within at the charging base system 310 (FIG. 3) within the power supply 314, but this approach may depend on a fast and reliable communications link from the charging receiver system 430 to the power supply 310 of FIG. 3 and in some cases may add complexity. As shown in FIG. 4, the charging receiver system 430 further includes a charging receiver system controller 444 to control the receive power converter 438 and other components of the charging receiver system 430.

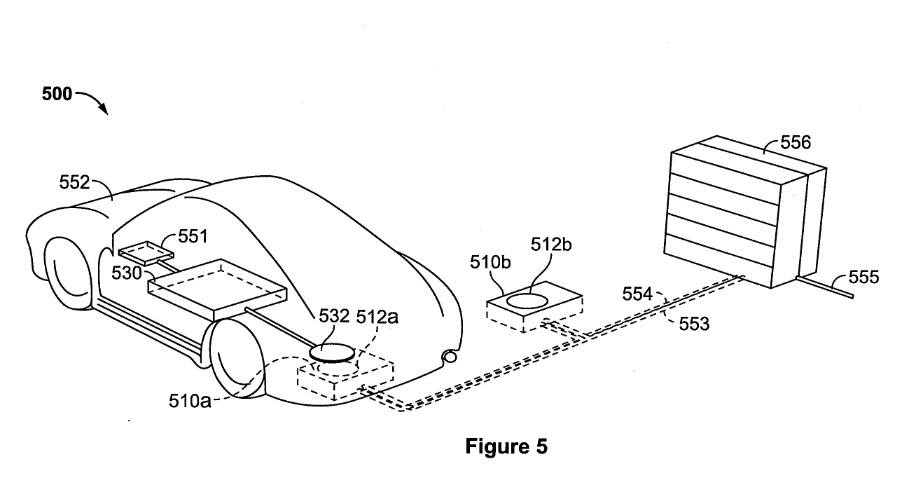

FIG. 5 is a diagram of an exemplary system 500 for charging an electric vehicle 552 that may include the wireless power transfer system 200 of FIG. 2, in accordance with various exemplary embodiments of the invention. The wireless power transfer system 500 may use one or more of the systems or components described above with reference to FIGS. 1-4. The wireless power transfer system 500 enables charging of an electric vehicle 552 while the electric vehicle 552 is parked near a charging base system 510a. Spaces for two electric vehicles are illustrated in a parking area to be parked over corresponding charging base systems 510a and 510b. Charging base systems 510a and 510b may be identical units, or they may differ in some respects, such as, e.g., power throughput, electric-vehicle compatibility, communication protocols, or servicing capabilities. In some embodiments, a local distribution center 556 may be connected to a power backbone 555 and configured to provide an alternating current (AC) or a direct current (DC) supply through a power link 553 to the charging base system 510a. The charging base system 510a also includes a transmit coil 512a as described above for wirelessly transferring or receiving power. An electric vehicle 552 may include a battery unit 551, a receive coil 532, and a receive power converter 530. The receive coil 532 may interact with the transmit coil 512a to wirelessly transfer power as described above.

Local distribution center 556 may be configured to communicate with external sources (e.g., a power grid) via a communication backhaul, and with the charging base system 510a via a communication link 554.

In some embodiments the receive coil 532 may be aligned with the transmit coil 512a and, therefore, disposed within a power transfer region simply by the driver positioning the electric vehicle 552 correctly relative to the transmit coil 512a. In other embodiments, the driver may be given visual feedback, auditory feedback, or combinations thereof to determine when the electric vehicle 552 is properly placed for wireless power transfer. In yet other embodiments, the electric vehicle 552 may be positioned by an autopilot system, which may move the electric vehicle 552 back and forth (e.g., in zig-zag movements) until an alignment error has reached a tolerable value. This may be performed automatically and autonomously by the electric vehicle 552 without or with only minimal driver intervention provided that the electric vehicle 552 is equipped with a servo steering wheel, ultrasonic sensors, and intelligence to adjust the vehicle. In still other embodiments, the receive coil 532, the transmit coil 512a, or a combination thereof may have functionality for displacing and moving the coils 532 and 512a relative to each other to more accurately orient them and develop more efficient coupling therebetween.

The charging base system 510a may be located in a variety of locations. As non-limiting examples, some suitable locations include a parking area at a home of the electric vehicle owner, parking areas reserved for electric vehicle wireless charging modeled after conventional petroleum-based filling stations, and parking lots at other locations such as shopping centers and places of employment.

Charging electric vehicles wirelessly provide numerous benefits. For example, charging may be performed automatically, virtually without driver intervention and manipulations thereby improving convenience to a user. There may also be no exposed electrical contacts and no mechanical wear out, thereby improving reliability of the wireless power transfer system 500. Manipulations with cables and connectors may not be needed, and there may be no cables, plugs, or sockets that may be exposed to moisture and water in an outdoor environment, thereby improving safety. There may also be no sockets, cables, and plugs visible or accessible, thereby reducing potential vandalism of power charging devices. Further, since electric vehicles may be used as distributed storage devices to stabilize a power grid, a convenient docking-to-grid solution may be desirable to increase availability of vehicles for vehicle-to-grid (V2G) operations.

A wireless power transfer system 500 may also provide aesthetical and non-impedimental advantages. For example, there may be no charge columns and cables that may be impedimental for vehicles and/or pedestrians.

As a further explanation of the vehicle-to-grid capability, the wireless power transmit and receive capabilities may be configured to be reciprocal such that the charging base system 510a transfers power to the electric vehicle 552 and the electric vehicle 552 transfers power to the charging base system 510a (e.g., in times of an energy shortage). This capability may be useful to stabilize the power distribution grid by allowing electric vehicles to contribute power to the overall distribution system in times of energy shortages caused by over-demand or a shortfall in renewable energy production (e.g., wind or solar).

It may be highly desirable that the charging station charging pad be integrated into or closely onto the pavement in a parking space and that the vehicle can park over the charging pad without precise alignment. Since the power required to charge an EV in a reasonable length of time is in the range of a few to several kilowatts, it may be highly desirable that there be low loss in the transmission of power from the charging pad to the pickup coil. It is also desirable that the charging station can be installed with a minimum of additional infrastructure, such as heavy utility lines or communications lines. It is also desirable that the magnetic fields generated by the wireless coupling of power be localized to the space between the charging pad and the vehicle pickup and minimized outside of this space to safe levels. An electric vehicle 552 is not limited to an automobile, and may include any type of vehicle that derives a portion of its power from an energy storage device, such as a battery. For example, an electric vehicle may include a motorcycle, a cart, a scooter, and the like. It should be appreciated while FIG. 5 shows an example of a wireless electric vehicle charging system 500, the systems and methods described herein apply equally to a charging system using a non-wireless connection. For example, a transmission line may be directly connected between the charging base system 510a and the receive power converter 530 that charges the battery 551. It may further be desirable that the source of power for the charging base system 510a not be dependent on fossil fuels.

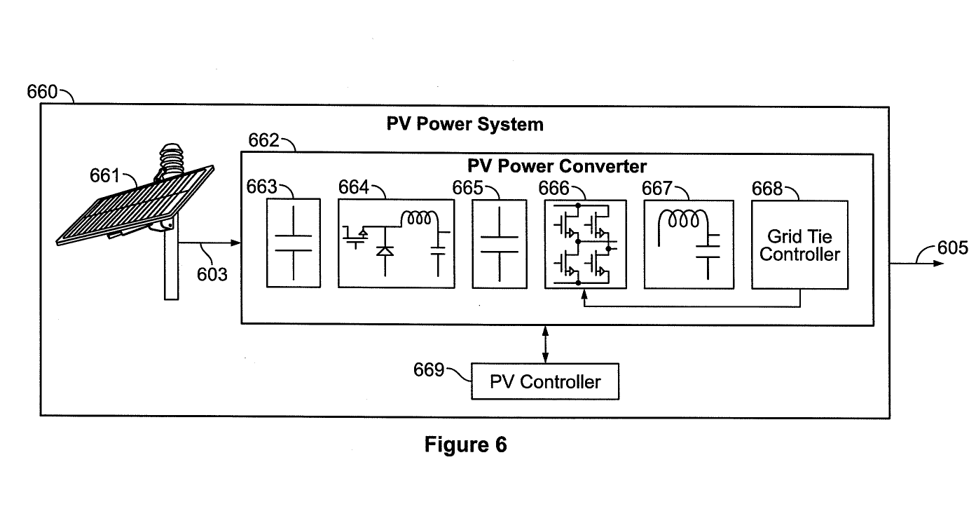

FIG. 6 is a functional block diagram of an exemplary photo voltaic (PV) power system 660 that provides power to a utility grid that could be used as a power source for an electric vehicle charging system 500 (FIG. 5). A system in which a PV power system 660 may be configured so as to avoid converting power for providing via a utility grid to the electric vehicle charging system 500 will be described below. The PV power system 660 shown in FIG. 6 includes a solar panel 661 that absorbs energy from the sun and generates DC electrical power 603. If used for charging an electric vehicle 552, this power may typically be a few hundred volts at a few tens of amps. The high voltage may be produced by connecting the photovoltaic cells in a series arrangement. High voltage transmission of power may reduce the current and minimize the resistive loss in the transmission wiring, thus reducing the size of the wire required to carry the power.

The PV power system 660 may include a PV power converter 662 and a PV controller 669 for controlling the PV power converter 662 and any other components of the PV power system 660. The PV power converter 662 includes an energy storage element 663 to provide a low impedance source for the subsequent high frequency circuits. The PV power converter 662 further includes a switch mode power supply 664 that may regulate the voltage to a fixed value, or to a value responsive to an external load. The components that make up the energy storage element 663 and switch mode power supply 664 may operate at high frequency and may be physically small. The PV power converter 662 may further include a second energy storage element 665 that may be configured to provide a low impedance source at 50/60 Hz. In this case, the energy storage element 665 may be configured as a large capacitor. The PV power converter 662 further includes a chopper circuit 666 configured to chop the DC current into 50/60 Hz square waves. The PV power converter 662 includes a filter 667 that is configured to suppress the harmonics of the square wave and convert the square wave into a sine wave. Filtering at 50/60 Hz may require very large and heavy components. One alternative may be to replace the simple chopper circuit 666 with a more complex sine wave converter circuit and reduce the filtering requirements on the filter 667. The PV power converter 662 includes a grid tie controller 668 configured to sense the frequency and phase of the utility grid connected to the output 605 and feeds back a control signal to the chopper circuit 666 to align the frequency and phase so that power flows from the PV power system 660 to the utility grid.

With reference to FIG. 5, charging of an electric vehicle 552 may be provided by main supplied 50/60 Hz power (such as from a power grid) that requires large, expensive, and inefficient components. For example, the components as shown in FIG. 3 may be very large and expensive at the power level required for charging an electric vehicle 552 by using power from the utility grid. Furthermore, with reference to FIG. 6, PV power systems may convert the DC produced by the solar panels into 50/60 Hz utility power, again requiring large and expensive components. In certain embodiments, AC power of about 20 KHz is used for wireless charging power. As such, in many cases, a conversion is required to convert power from to 20 KHz, either from 50/60 Hz to 20 KHz, or from DC to 20 KHz.

The time required to charge a parked electric vehicle 552 provides one obstacle to the wider acceptance of clean energy transportation. The common view is that charging would take place over night at the residence of the electric vehicle owner. Photo Voltaic (PV) sources (e.g., solar energy sources) may provide a beneficial localized source of clean energy. However, this power source is generally limited to being available during daylight hours. Locally generated photo voltaic power may be converted to AC power that is compatible with the commercial power mains and run into the utility grid (i.e., “running the meter backwards” method of storing energy). The battery in an electric vehicle 552 may be used as a storage element, charging up during times of low electrical power demand and drawing from the battery at peak times. This proposal (vehicle-to-grid) may result in wearing of the battery out prematurely and depleting the battery when the owner wants to drive the electric vehicle 552. According to some designs, charging an electric vehicle 552 during the day from a utility grid may be avoided because it coincides with when electrical power demand (and therefore price) is at its peak. However, during the day is also when the most power is available from photo voltaic sources.

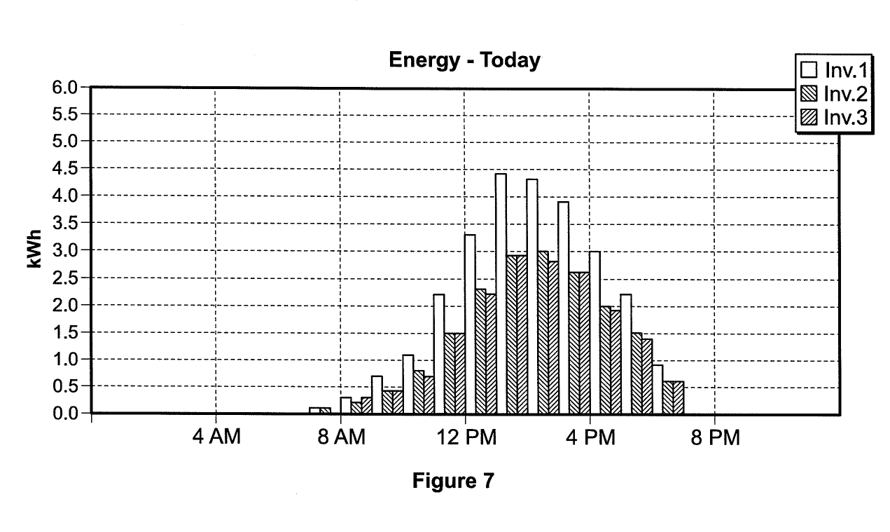

According to certain aspects of the disclosure, an improved “green” solution may be for a solar charging station to be installed where the electric vehicle 552 is parked during the day. For example, an employer could offer charging stations as a benefit of employment, just as a parking space is now expected and provided. FIG. 7 is a chart showing an exemplary hypothetical amount of solar power available during a period of a day when using an exemplary PV power source. For example, as illustrated by FIG. 7, a vehicle parked at the place of employment from 9 am to 5 μm may capture the majority of the daily solar power available. Providing converted solar energy directly to a vehicle may avoid power conversion to and from the utility grid for the purpose of virtual storage. The efficiency of dedicating the solar plant may outweigh energy lost in hours outside of the normal work day. In addition, the cost of solar panels has dropped to the point that avoiding peripheral costs, such as construction of power feeds, is important and it is not necessary to squeeze out every watt-hour from every installed solar panel. As will be described in more detail below, avoiding conversion to and from the power utility grid significantly simplifies the required circuitry to convert power from the solar plant to a charging base system. Simplifying the circuitry reduces the losses from multiple conversions, improves the overall system efficiency, and decreases the cost involved.

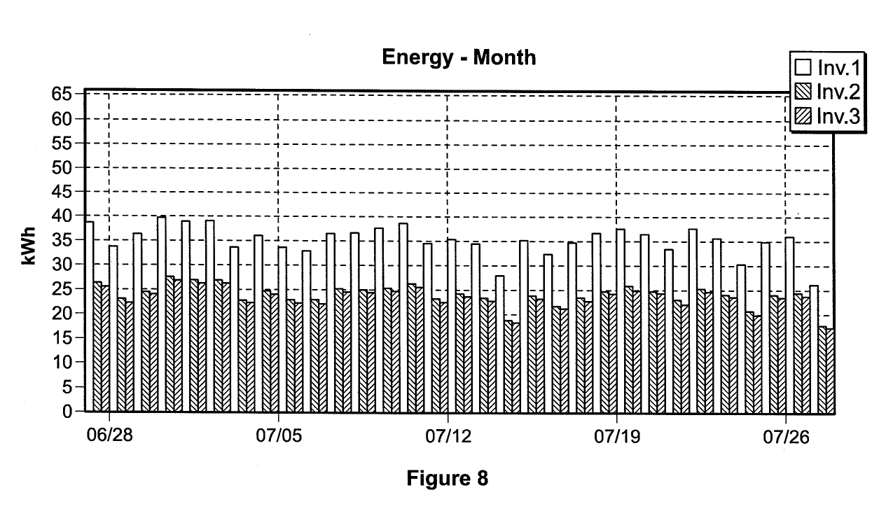

FIG. 8 is a chart illustrating a hypothetical amount of solar energy produced by an exemplary photo voltaic source (i.e., photo voltaic installation) over a time period of one month. As shown by FIG. 8, solar energy per day is fairly consistent over a month and may be practical for direct electric vehicle charging. Having a source of energy to charge an electric vehicle that does not need to be connected into a power grid may make installation easier as transmission lines may be needed only from a photo voltaic source to the electric vehicle parking space. For example, retrofitting parking lots and parking structures may be easier and would reduce or eliminate a need for trenching for underground utility lines to connect each parking spot to the utility grid.

As stated and shown above with reference to FIGS. 2-3 and 6, conversion of DC power to or from 60 Hertz AC may require either heavy and expensive magnetic components or complex electronics. For the power levels required by electric vehicle 552 charging, power factor (PF) correction 664 may be needed, adding further complexity and expense. When using a utility grid, a DC to 50/60 Hz AC conversion may be used at the photo voltaic source and a 50/60 Hz AC to DC conversion may be used at an electric vehicle charging based system 510a.

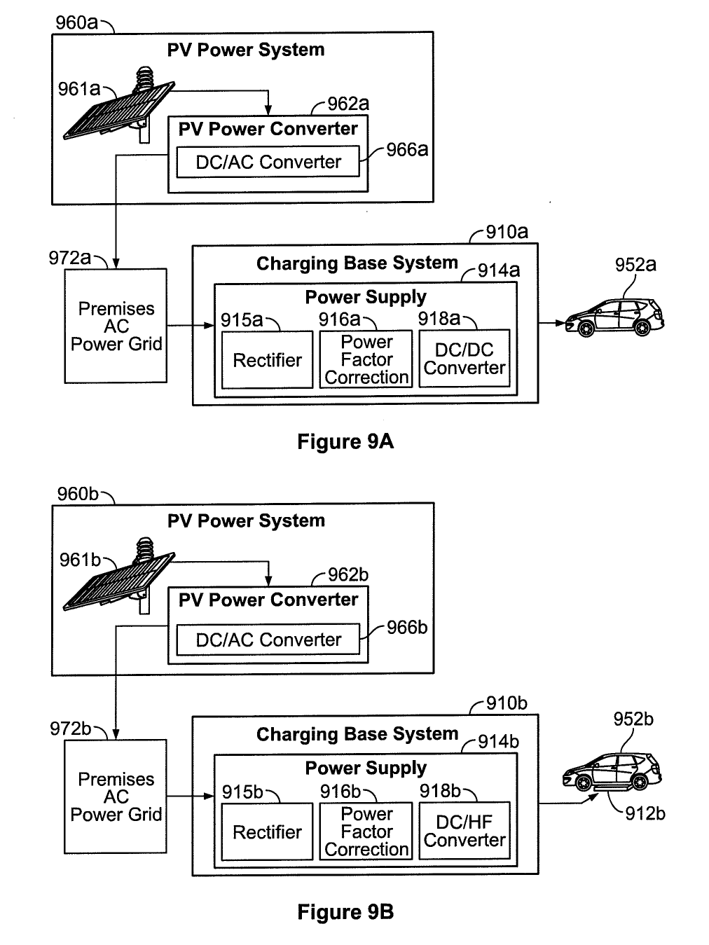

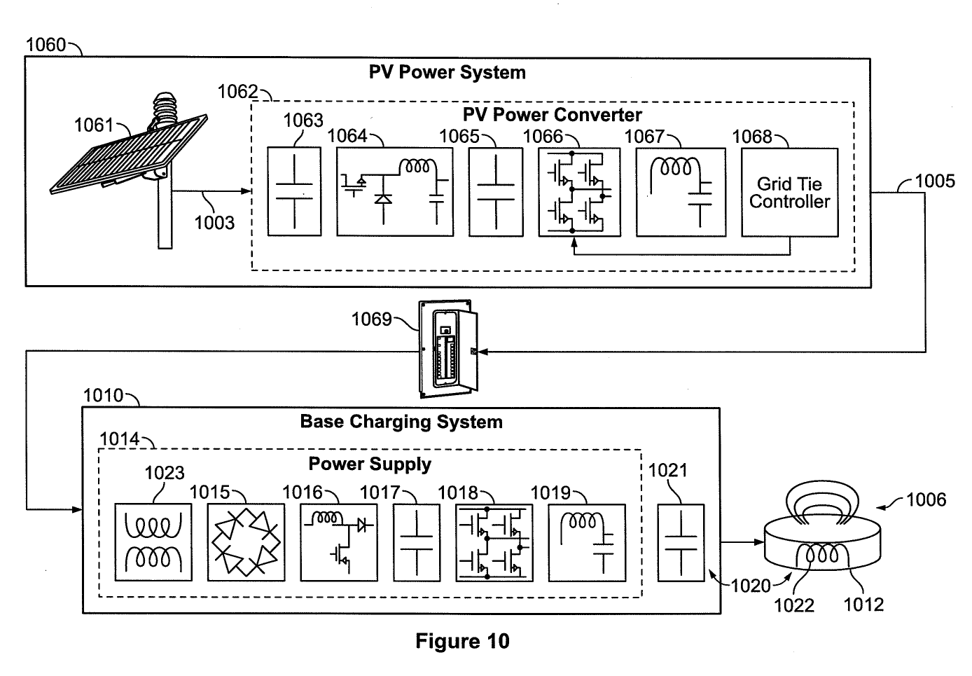

For example, FIG. 9A is a functional block diagram of an exemplary wired charging base system 910a that receives power from a PV power system 960a via an AC power utility grid 972a. As shown in FIG. 9A solar energy is received and converted into an electrical current at PV power system 960a including a solar panel 961a and a PV power converter 962a. The DC electrical current generated by the solar panel 961a is converted into AC power via the PV power converter 962a which includes a DC/AC converter 966a that may be compatible with a power grid 972a. The power is then sent via a power grid 972a to a charging base system 910a for charging electric vehicle via a transmission line from the charging base system 910a to the electric vehicle 952a. The charging base system 910a includes a power supply 914a that includes a rectifier 915a to convert received AC current to DC current. The DC current from the rectifier 915a is converted via a power factor correction circuit 916a and a DC/DC converter 918a for use in charging the electric vehicle 952a via a transmission line. The components and blocks shown in FIG. 9A may make use of one or more of the components shown in FIGS. 1-6 which in some cases may be heavy and expensive when used to convert power via the utility grid 972a.

As an additional example, FIG. 9B is a functional block diagram of an exemplary wireless charging base system 910b that receives power from a PV power system 960b via an AC power utility grid 972b. While similar to the conversion shown in FIG. 9A, in FIG. 9B, the charging base system 910b converts power received from a grid into DC current via a rectifier 915b and then converts the DC current to high frequency via a DC/HF converter 918b that may be used to wirelessly charge the electric vehicle 952b (e.g., through the use of resonant induction as described above). As such, the PV power system 960b includes a PV power converter 962b that receives DC generated by a solar panel 961b and converts it via a DC/AC converter 966b to be compatible and provide to a utility AC power grid 972b. The charging base system 910b receives power from the power grid 972b and converts the AC power using a power supply 914b. As just described, the power supply 914b includes a rectifier 915b that produces direct current based on the AC power received. The direct current is the converted to high frequency AC via power factor correction circuitry 916b and a DC/HF converter 918b to drive a transmit coil 912b for wirelessly transferring power. The components and blocks shown in FIG. 9B may make use of one or more of the components shown in FIGS. 1-6 which in some cases may be heavy and expensive when used to convert power via the utility grid 972b.

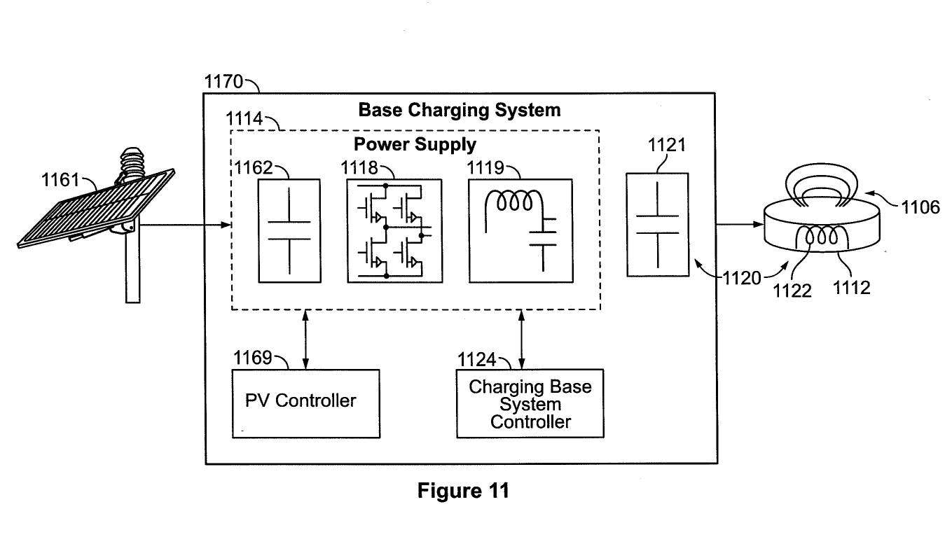

FIG. 10 is a functional block diagram of additional components that may be used for power conversion in the exemplary system shown in FIG. 9B to further show the complexity and cost when providing power via a 50/60 Hz utility grid from a renewable energy source. As shown in FIG. 10, solar energy is received and converted into an electrical current using a PV power system 1060 including a photo voltaic source 1061 that generates DC electrical current. The DC electrical current 1003 is converted into AC power 1005 by a PV power converter 1062 such that the AC power 1005 is compatible for providing to a power grid 1069. As described above with reference to FIG. 6, the PV power converter may include an energy storage element 1063, power factor correction circuitry 1064, a second energy storage element 1065, a chopper circuit 1066, a filter 1067, and a grid tie controller 1068. As described above, the conversion to 50/60 Hz AC may require expensive and large components. The power 1005 is then sent via a power grid 1069 to a base charging system 1010. The base charging system includes a power supply 1014 that converts the AC power into high frequency AC power that may be used to drive the transmit coil 1012. As described above with reference to FIG. 3, the power supply 1014 may include a line filter 1023 and a rectifier 1015 for converting received AC current to DC current. The DC current is converted via power factor correction circuitry 1016, an energy storage element 1017, and a DC/AC converter 1018 (e.g., chopper circuit). A filter 1019 is additionally provided to convert the square wave to a sine wave and remove harmonic content. The converted alternating current from the power supply 1014 drives a power transmit circuit 1020 including a capacitor 1021 and the transmit coil 1012 forming an inductor 1022 as described above with reference to FIG. 3. The frequency of the converted AC may be configured to be substantially the frequency at which the power transmit circuit 1020 resonates. The transmit coil 1012 may then be used to wirelessly provide power for charging an electric vehicle 552 (FIG. 5). In this case, where a wireless connection is desired to charge the EV, the 50/60 Hz AC utility power may have to be converted to a higher frequency such as 20 KHz (e.g., higher frequency that is typically in the range of 400 Hz to 1 MHz) to allow the magnetic components of the wireless connection to be smaller and more efficient.

According to various embodiments of apparatus or methods, charging of an electric vehicle 552 may be done using as little power as possible from the utility grid and as much power as possible (and to improve charging efficiency) by moving energy from the photo voltaic energy source to the electric vehicle 552 without inefficiencies that conversions to and from power that is compatible with the utility grid create.

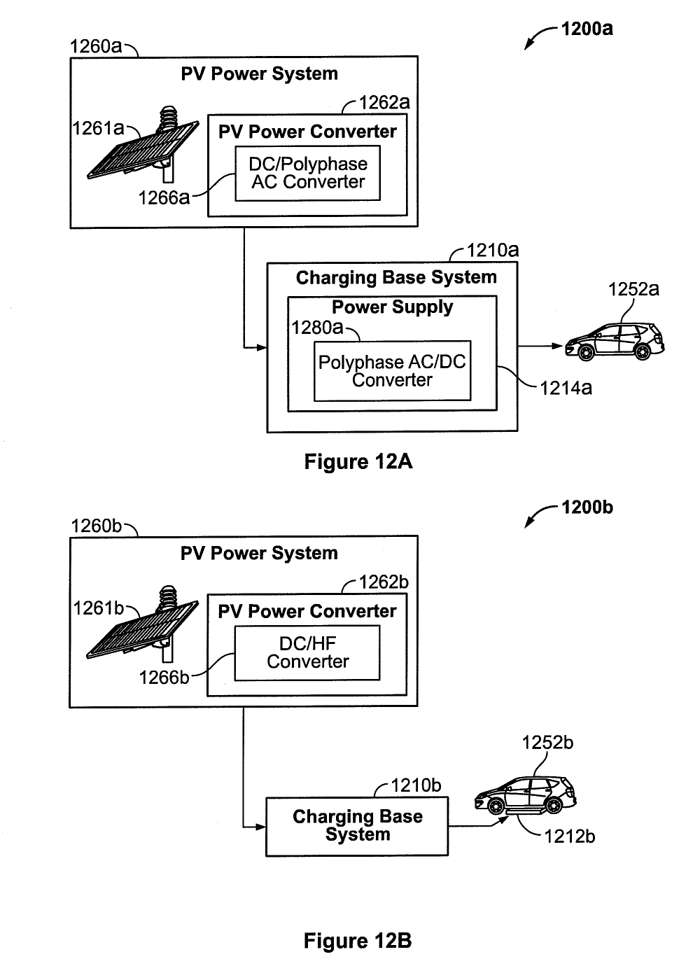

FIG. 11 is a functional block diagram of a base charging system 1170, in accordance with various exemplary embodiments of the invention. In contrast to the systems described above, the base charging system 1170 may be configured to wirelessly charge an electric vehicle 552 (FIG. 5) using power received directly from renewable power source such as a PV power source 1161. The base charging system 1170 of FIG. 11 performs a similar function as the system depicted in FIG. 10, however the conversion to and from the 50/60 Hz power utility grid is eliminated. PV power source 1161 generates DC current that is converted by a power supply 1114 directly into the high frequency AC current that drives the transmit coil 1112, which generates the alternating magnetic field 1106 that couples to a receive coil 532 (FIG. 5), on the underside of the electric vehicle 552 (FIG. 5). The power supply 1114 includes an energy storage element 1162 to provide a low impedance source for the high frequency chopper circuit 1118. The chopper circuit 1118 converts the generated DC into AC at the desired operational frequency used to drive a power transmit circuit 1120. The power supply 1114 includes a filter 1119 that is configured to reduce the harmonic content of the square wave produced by chopper circuit 1118. The converted AC is provided to the power transmit circuit 1120 including a capacitor 1121 and the transmit coil 1112 forming an inductor 1122 to form a resonant tank circuit. The frequency of the converted AC may be configured to be substantially equivalent to an operating frequency at which the power transmit circuit 1120 resonates. The power transmit circuit 1120 may function as described above with reference to FIGS. 1-5. In addition, the base charging system 1170 includes a charging base system controller 1124 and a PV controller 1169 that may be combined in some cases.

As shown in FIG. 11, this configuration reduces the number and type of components from that required in the configuration depicted in FIG. 10. All of the large, heavy and expensive 50/60 Hz components have been eliminated. In addition, the complexity of synchronizing the DC to AC conversion with the utility grid is eliminated. Also, the complexity of the power factor correction circuit has been eliminated as well as the inefficiency of multiple conversions, and the grid-tie synchronization. Only a single, high efficiency DC to high frequency AC conversion remains. The direct conversion may be implemented as single phase or polyphase, as required by the charging pad design and the amount of power to be supplied to the electric vehicle. The advantages of integrating the solar plant controller with the EV charger controller are many.

According to one embodiment, therefore, the DC power of the PV power source 1161 may be connected directly to power the base charging system 1170. In this case, safety issues may have to be accounted for. For example, heavy copper wire from a roof mounted solar installation to a ground level base charging system 1170 may be expensive as switching and overcurrent devices for high power DC are expensive due to the difficulty of breaking DC current. In some embodiments, DC power from the photo voltaic source may be converted to polyphase AC, three phase AC or six phase AC. In some cases, Polyphase AC may reduce problems of converting to DC at the photo voltaic charging station.

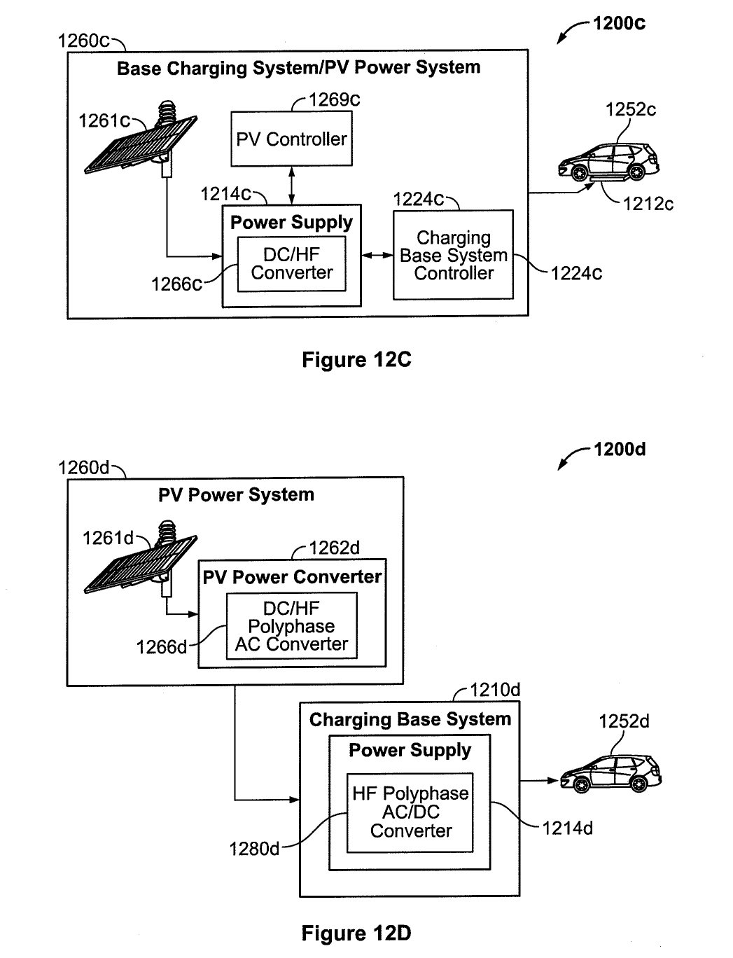

It should be appreciated that while the power supply 1114 including the power conversion circuitry is shown within the base charging system 1170, the power conversion circuitry may form part of a PV power converter located as part of a PV power system and then fed to a base charging system 1170. A variety of different configurations for the location of the power conversion circuitry are possible. However, in each configuration, a DC current generated by a PV power source 1161 may be converted directly into AC at a frequency that is appropriate for use in wirelessly charging an electric vehicle 552, using for example, resonant inductive power transfer. As such, any conversion to lower frequencies requiring large or expensive components along with power factor correction would be unnecessary. FIGS. 12A, 12B, 12C, and 12D are functional block diagrams of different configurations of base charging systems receiving power from PV power systems, in accordance with various exemplary embodiments of the invention.

FIG. 12A is a functional block diagram showing an exemplary system 1200a for charging an electric vehicle 1252a via a wired connection using a PV power system 1260a as a power source that converts DC into polyphase alternating current (AC). The PV power system 1260a includes a PV power converter 1262a that includes a DC/Polyphase AC converter 1266a. The DC/Polyphase AC converter 1266a converts DC generated by the solar panel 1261a into polyphase AC. The polyphase AC is provided directly to a charging base system 1210a which includes a power supply 1214a including a polyphase AC/DC Converter 1280a. The polyphase AC/DC Converter 1280a converts the polyphase AC into direct current that may be provided via a transmission line or other electrical connection to charge a battery of an electric vehicle 1252a.

FIG. 12B is a functional block diagram showing an exemplary system 1200b for wirelessly charging an electric vehicle 1252b using a PV power system 1260b as a power source that converts direct current into high frequency alternating current (AC). The PV power system 1260b includes a PV power converter 1262b that includes a DC/HF converter 1266b that converts direct current generated by a solar panel 1261b into high frequency AC that is compatible with wireless coupling to the electric vehicle 1252b. As stated, this may allow the conversion components at the PV power converter 1262b to be smaller and more efficient. The output of the PV power converter 1262b may be at a high voltage to allow the use of smaller conductors in the transmission line between the PV power system 1260b and the charging base system 1210b. The high voltage, high frequency signal may be stepped down at the charging base system 1210b by a small and inexpensive high frequency transformer (not shown). The signal may then be used directly by the magnetic coupling transmitter coil(s) 1212b to charge the electric vehicle 1252b. In either the wired or wireless cases, the components to convert to DC to charge the battery are much smaller, less expensive and more efficient than the equivalent required by 60 Hertz utility power.

FIG. 12C is another functional block diagram showing an exemplary system 1200c for wirelessly charging an electric vehicle 1252c. As shown in FIG. 12C, the components of the PV power system and the base charging system may be included in a shared housing. The system 1200c may therefore have a base charging system/PV power system 1260c that includes a PV controller 1269c and a charging base system controller 1224c. In some embodiments the PV controller 1269c and the charging base controller 1224c may be the same controller. The base charging system/PV power system 1260c includes a power supply 1214c including a DC/HF converter 1266c configured to convert direct current generated by a solar panel 1261c into high frequency AC that may be used directly to drive a transmit coil 1212c for wirelessly transferring energy to charge an electric vehicle 1252c. The DC/HF converter may include the components shown in the power supply 1114 of FIG. 11. As shown, the PV controller 1269c, the charging base system controller 1224c, and any conversion circuitry as shown in the power supply 1214c may share a common housing. In some embodiments, therefore, only a transmit coil 1212c may be embedded under a parking area. As such, as shown in FIG. 12C, charging base system controller 1224c may be integrated in the photo voltaic source installation 1260c such that transmitter coils 1212c alone would be located near the electric vehicle 1252c while other functionality of the system would be integrated in or close by the photo voltaic source installation 1260c. This may allow for greater modularity as power sources may be connected and disconnected with greater ease and charging systems may be added on an as need basis. Furthermore, installation may be easier as modular components may be brought in and connected to embedded transmit coils.

FIG. 12D is another functional block diagram showing an exemplary system 1200d for charging an electric vehicle 1252d. According to this embodiment, aspects of the two embodiments described above may be combined. For example, the DC power at the PV power system 1260d may be converted to an HF polyphase signal, optionally transformed to a higher voltage for smaller transmission line conductors, and used directly by the charging base system 1210d for charging the electric vehicle 1252d. In FIG. 12D, the PV power system 1260d includes a PV power converter 1262d including a DC/HF polyphase AC converter 1266d configured to convert direct current generated by a solar panel 1261d into high frequency polyphase alternating current. The HF polyphase AC is provided directly to a charging base system 1210d that includes a power supply 1214d including a HF polyphase AC/DC converter 1280d. The HF polyphase AC/DC converter 1280d may be used to convert the HF polyphase AC into direct current for charging an electric vehicle 1252d via a transmission line or other electrical connection.

In another embodiment, the HF polyphase signal provided by the DC/HF polyphase AC converter 1266d could be used by a wireless charging base system (not shown) that uses a three coil wireless charging pad (not shown). The wireless charging base system (not shown) may directly use the three phase power from the PV power system 1260d to drive the three coil wireless charging pad so as to require less alignment between the electric vehicle 1252d and the three coils.

It should be appreciated that while the PV power systems described above are described with reference to solar panels, the embodiments described herein may employ any type of PV power system with components that provide direct current based on solar energy sources. Furthermore, while the embodiments described herein are described with reference to PV power systems, the embodiments described herein may make use of any appropriate renewable energy source that provides electric energy that may be directly converted for use by a base charging system for charging an electric vehicle. For example, systems that may be used in place of the PV power system described above may include wind power sources, hydropower sources (e.g., currents, tides, waves), geothermal sources, bio energy sources (e.g., biomass, biofuel), and the like.

DC power generated by PV power systems may need to be converted to AC for more efficient switching and control and step up/down to a different voltage appropriate for transmission and use. Many residential and commercial utility grids may use single phase power. Three phase power may generally be found in industrial settings. If a PV power system need not feed power into the utility grid, the PV power system may be free to generate three or more phases for transmission to the EV charger.

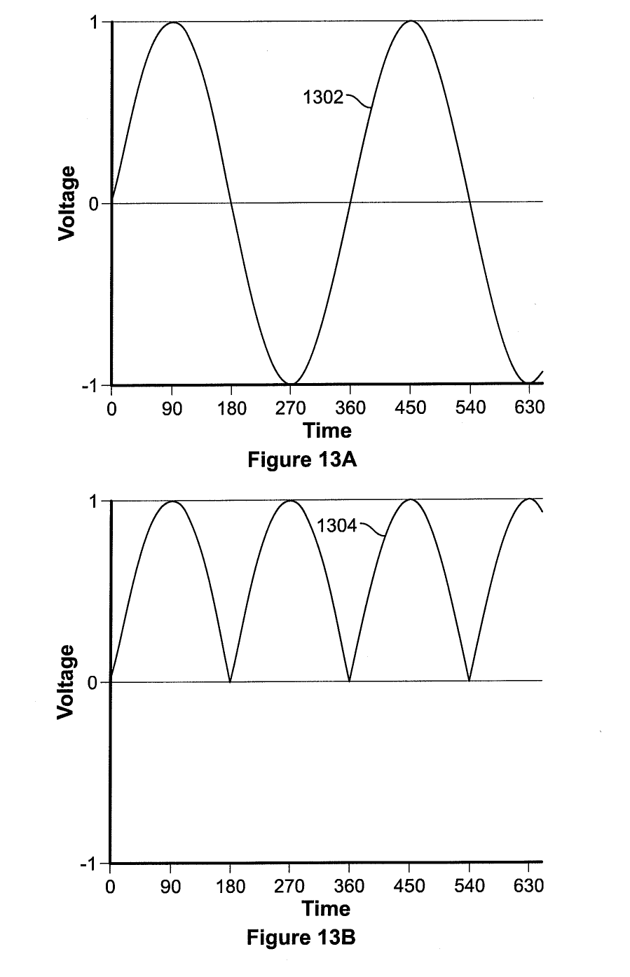

As described above with reference to FIGS. 12A-12D, polyphase power may be used for providing power from a PV power system to a base charging system. FIGS. 13A, 13B, 13C, 13D, and 13E are plots of exemplary DC and AC voltage waveforms for both single phase and polyphase power conversion systems, in accordance with exemplary embodiments of the invention. FIG. 13A shows a waveform 1302 according to single phase AC power shown as a single sine wave. In a 50/60 Hz power grid, this wave has a period of approximately 16.66 milliseconds. Converting the wave shown in FIG. 13A to DC may include rectifying the single phase power with a full wave rectifier to form the waveform 1304 as shown in FIG. 13B. Now the power is unidirectional, but it is in the form of half-sine pulses of duration approximately 8.33 milliseconds and points on the waveform 1304 that drop to zero volts as shown by FIG. 13B. Once rectified, conversion may further include filtering the pulses into a smooth, constant DC. Filter components may require enough energy storage capacity to supply the load over much of the 8.33 millisecond period. At the power levels required for EV charging these components may be expensive, bulky and heavy.

FIG. 13C shows a waveform 1306 according to 3-phase power shown as three sine waves that are each 120 degrees apart in phase. Power in this format may provide for efficient generation, transmission and use. It may also provide several benefits for efficient conversion from AC to DC. FIG. 13D shows a waveform 1308 according to rectified 3-phase power. The rectified 3-phase waveform 1308 shown in FIG. 13D shows the overlapping pulses of DC. When the pulses are summed together the result is DC with a small amount of ripple as shown by the waveform 1310 of FIG. 13E. The ripple frequency may be three times higher than with single phase power. This combination may allow for smaller filter components for smoothing the DC output than the single phase case as shown in FIG. 13B.

If a basic AC frequency is increased from the 60 Hertz used in the utility grid to 20 KHz as may be used in wireless electric vehicle charging applications, the ripple frequency may be increased by a factor of about 166. Energy storage for a ripple filter for a 3-phase 20 KHz converter may be a tiny fraction of a single phase 50/60 Hz converter, adding efficiency and reducing size and cost.

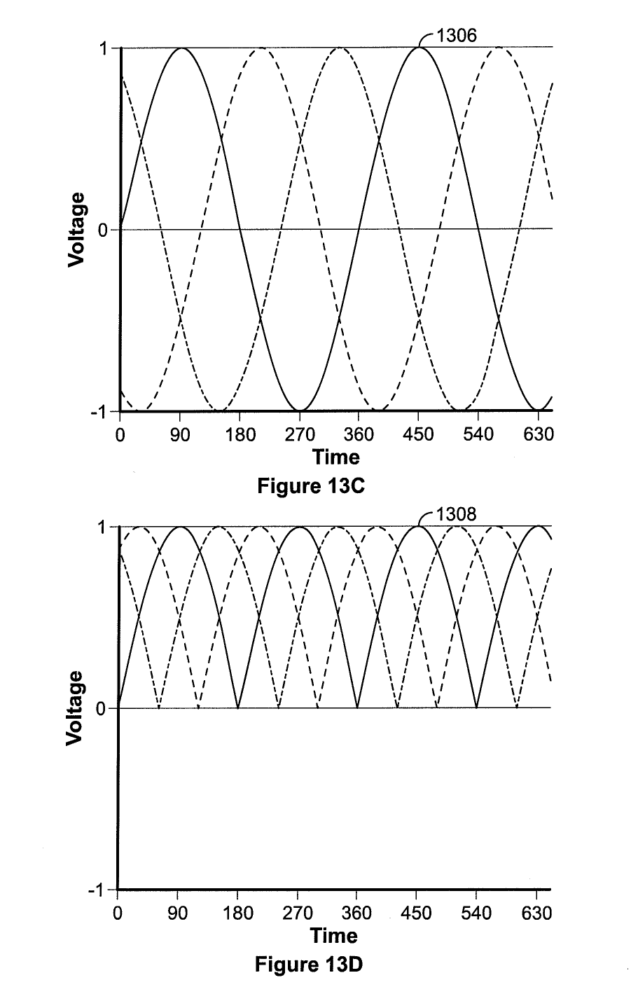

Three phase power may need an additional conductor as compared to single phase power along with using six diodes in the rectifier instead of four. FIG. 14 is a schematic diagram of an exemplary three phase full wave rectifier circuit 1400, in accordance with an exemplary embodiment of the invention. In the case of electric vehicle charging power levels, additional components may be mitigated by having the power spread across additional conductors and additional diodes so that smaller components may be used.

Accordingly, matching the photo voltaic solar plant with the electric vehicle 612 charging station for daytime vehicle charging may eliminate compromises required by being tied to the utility grid. Using HF polyphase AC for the transmission line between the photo voltaic and electric vehicle 612 may reduce component size and expense and improves efficiency.

If utility power is desired to be used as a backup to a renewable energy source, the 60 Hertz to DC converter may be implemented to be smaller than required if it were the primary source of charging. Especially in the case of a multi-vehicle charging station, the utility power backup could be undersized to handle only the minimum case recharging requirement, such as providing only a slow charge instead of a rapid charge capability that would drive the converter to much larger components.

Many commute vehicles may use less than the full charge every day. As such, charging with solar power available on a cloudy day may keep the vehicle usable for the commute, while only several sequential cloudy days may require charging from the utility grid. This “last-resort” charging may take place at a different charging station apart from the embodiments described above, avoiding a need for utility grid backup on the majority of charging stations.

In the embodiments above, there may be a removable connector between the PV power system and a charging base system. This may allow for selectively connecting different power sources to the charging base system. For example, the charging base system may include minimal power conversion circuitry, or selectively enabled power conversion circuitry, such that different power converters, converting power from various types of power sources, could be connected to the charging base system and provide directly converted power for charging the electric vehicle. This may allow the charging base system to switch between different power sources such as between a PV power system and a utility gird, or between different renewable power sources that may allow for easier installation.

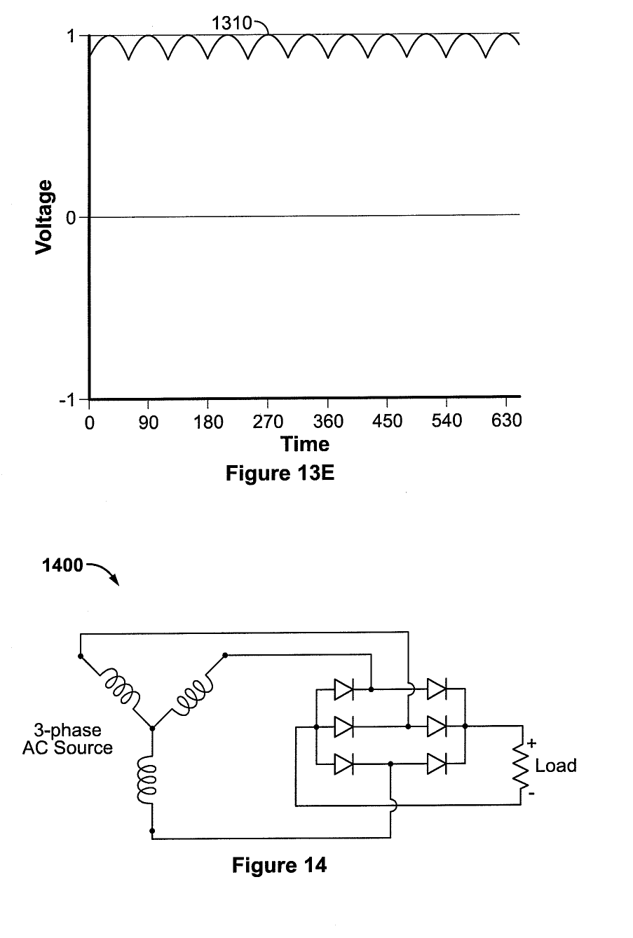

FIG. 15 is a flowchart of an implementation of an exemplary method 1500 for charging an electric vehicle. In block 1502, and with reference to FIG. 11, a power supply 1114 may be configured to convert direct current received from a renewable power source into alternating current that has a desired frequency. In block 1504, a base charging system 1170 may be configured to provide power to charge an electric vehicle 552 (FIG. 5) via a power transmit circuit 1120 using the alternating current supplied from the power supply 1114. The power transmit circuit 1120 may be configured to substantially resonate at the frequency of the alternating current. The method 1500 may further include filtering the alternating current. The renewable power source may be a photo voltaic solar plant or any other renewable power source as described above. The power transmit circuit 1120 may be configured for wirelessly transferring power to charge the electric vehicle. The power transmit circuit 1120 may include a coil 1112 with an inductance L and a capacitive element 1120 with a capacitance C, the inductance and capacitance selected to cause the power transmit circuit 1120 to resonate at substantially the frequency of the alternating current. The frequency of the alternating current may be between 10 KHz and 100 KHz. The power transferred by power transmit circuit 1120 may be at least 1 kilowatt. In some embodiments, the alternating current may be polyphase alternating current. Converting direct current shown in block 1502 may include converting the direct current into alternating current without conversion of the direct current through a utility grid.

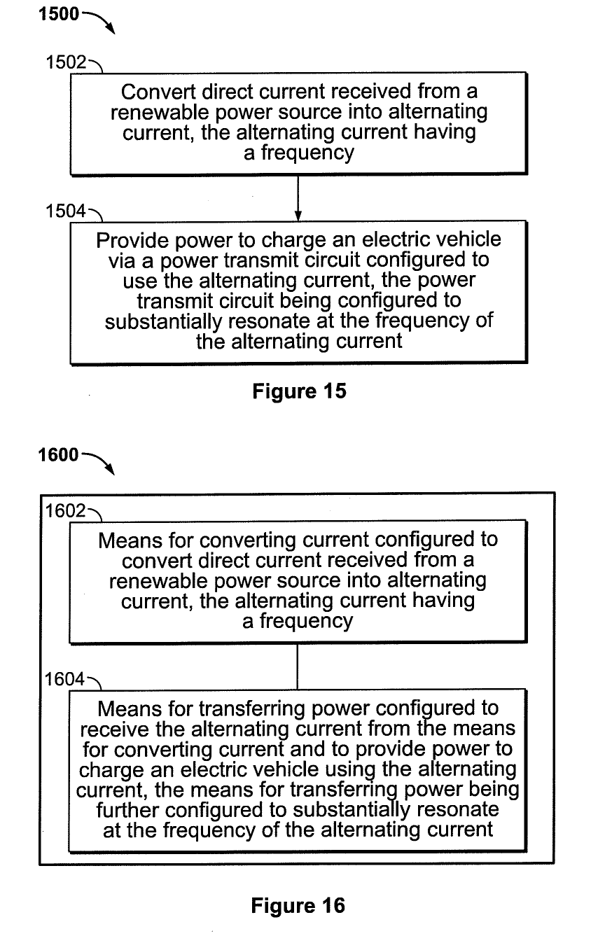

FIG. 16 is a functional block diagram of a charging base system 1600 for charging an electric vehicle 552 (FIG. 5), in accordance with an exemplary embodiment of the invention. Charging base system 1600 includes means 1602 and 1604 for the various actions discussed with respect to FIGS. 1-15.

The various operations of methods described above may be performed by any suitable means capable of performing the operations, such as various hardware and/or software component(s), circuits, and/or module(s). Generally, any operations illustrated in the figures may be performed by corresponding functional means capable of performing the operations. For example, with reference to FIG. 11, means for converting current may include a power supply 1114 including power conversion circuitry for converting direct current received from a renewable power source into alternating current having a frequency. Means for transferring power may include a power transmit circuit 1120 configured to be driven with the alternating frequency as described above. Means for storing energy may include an energy storage element 1162 such as a capacitor. Means for DC/AC conversion may include a chopper circuit 1118 or other DC/AC converter circuitry. Means for filtering may include a filter circuit 1119.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, circuitry, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus configured for charging an electric vehicle, comprising:
a power supply circuit configured to convert direct current received from a renewable power source into alternating current, the alternating current having a frequency; and
a power transmit circuit configured to receive the alternating current from the power supply circuit and to provide power to charge the electric vehicle using the alternating current, the power transmit circuit being further configured to substantially resonate at the frequency of the alternating current.

2. The apparatus of claim 1, wherein the power supply circuit comprises:
an energy storage element configured to receive the direct current from the renewable power source;
a chopper circuit electrically connected to the energy storage element and configured to receive the direct current from the energy storage element and to output the alternating current; and
a filter circuit electrically connected to the chopper circuit and configured to filter the alternating current.

3. The apparatus of claim 1, wherein the power transmit circuit comprises a coil and a capacitive element, wherein the coil has an inductance L and the capacitive element has a capacitance C selected to cause the power transmit circuit to resonate at substantially the frequency of the alternating current.

4. The apparatus of claim 1, wherein the renewable power source comprises at least one of a photo voltaic power source, a wind power source, a hydropower source, a biofuel power source, a geothermal power source, and any combination thereof.

5. The apparatus of claim 1, wherein the power transmit circuit is configured to wirelessly provide power for charging the electric vehicle.

6. The apparatus of claim 1, wherein the frequency of the alternating current is between 10 KHz and 100 KHz.

7. The apparatus of claim 1, wherein the power transmit circuit is configured to supply at least 1 kilowatt of power to the electric vehicle.

8. The apparatus of claim 1, wherein the renewable power source comprises a first controller, wherein the apparatus further comprises a second controller, and wherein the power supply circuit, the first controller, and the second controller are located in a shared housing.

9. The apparatus of claim 1, wherein the power transmit circuit is configured to receive the alternating current via a removable connector.

10. The apparatus of claim 1, wherein the alternating current comprises a polyphase alternating current.

11. The apparatus of claim 1, wherein the power supply circuit is configured to convert the direct current into alternating current without the direct current being converted to pass through a utility grid.

12. A method for charging an electric vehicle, the method comprising:
converting direct current received from a renewable power source into alternating current, the alternating current having a frequency; and
providing power to charge the electric vehicle via a power transmit circuit configured to use the alternating current, the power transmit circuit being further configured to substantially resonate at the frequency of the alternating current.

13. The method of claim 12, wherein converting comprises filtering the alternating current.

14. The method of claim 12, wherein the renewable power source comprises at least one of a photo voltaic power source, a wind power source, a hydropower source, a biofuel power source, a geothermal power source, and any combination thereof.

15. The method of claim 12, wherein providing power comprises wirelessly providing power for charging the electric vehicle.

16. The method of claim 12, wherein the frequency of the alternating current is between 10 KHz and 100 KHz.

17. The method of claim 12, wherein providing power comprises providing at least 1 kilowatt of power to the electric vehicle.

18. The method of claim 12, wherein the alternating current comprises a polyphase alternating current.

19. The method of claim 12, wherein converting comprises converting the direct current into alternating current without conversion of the direct current through a utility grid.

20. The method of claim 12, wherein the power transmit circuit comprises a coil and a capacitive element, wherein the coil has an inductance L and the capacitive element has a capacitance C selected to cause the power transmit circuit to resonate at substantially the frequency of the alternating current.

21. An apparatus for charging an electric vehicle comprising:
means for converting direct current received from a renewable power source into alternating current, the alternating current having a frequency; and
means for transferring power configured to receive the alternating current from the means for converting current and to provide power to charge the electric vehicle using the alternating current, the means for transferring power being further configured to substantially resonate at the frequency of the alternating current.

22. The apparatus of claim 21, wherein the means for converting current comprises:
means for storing energy configured to receive the direct current from the renewable power source;
means for DC/AC conversion electrically connected to the means for storing energy and configured to receive the direct current from the means for storing energy and to output the alternating current; and
means for filtering the alternating current, the means for filtering electrically connected to the means for DC/AC conversion.

23. The apparatus of claim 21, wherein the means for transferring power further comprises a coil and a capacitive element, wherein the coil has an inductance L and the capacitive element has a capacitance C selected to cause the means for transferring power to resonate at substantially the frequency of the alternating current.

24. The apparatus of claim 21, wherein the renewable power source comprises at least one of a photo voltaic power source, a wind power source, a hydropower source, a biofuel power source, a geothermal power source, and any combination thereof.

25. The apparatus of claim 21, wherein the means for transferring power comprises means for wirelessly providing power for charging the electric vehicle.

26. The apparatus of claim 21, wherein the frequency of the alternating current is between 10 KHz and 100 KHz.

27. The apparatus of claim 21, wherein the means for transferring power comprises means for supplying at least 1 kilowatt of power to the electric vehicle.

28. The apparatus of claim 21, wherein the renewable power source comprises a first controller, wherein the apparatus further comprises a second controller, and wherein the means for converting current, the first controller, and the second controller are located in a shared housing.

29. The apparatus of claim 21, wherein the means for transferring power comprises means for receiving the alternating current via a removable connector.

30. The apparatus of claim 21, wherein the alternating current comprises a polyphase alternating current.

31. The apparatus of claim 21, wherein the means for converting current comprises means for converting the direct current into alternating current without the direct current being converted to pass through a utility grid.

32. The apparatus of claim 21, wherein the means for converting current comprises a power supply circuit, and wherein the means for transferring power comprises a power transmit circuit.

33. The apparatus of claim 22, wherein the means for storing energy comprises an energy storage element, wherein the means for DC/AC conversion comprises a chopper circuit, and wherein the means for filtering comprises a filter circuit.
